(19) United States
(12) Patent Application Publication
(10) Pub. No.: US 2026/0005852 A1
(43) Pub. Date: Jan. 1, 2026

(54) IMAGE PROCESSING APPARATUS AND SETTING METHOD

(71) Applicant: SHARP KABUSHIKI KAISHA, Osaka (JP)

(72) Inventor: Hiroyuki AOYAGI, Osaka (JP)

(21) Appl. No.: 19/243,802

(22) Filed: Jun. 20, 2025

(30) Foreign Application Priority Data
Jun. 26, 2024 (JP) 2024-103191

(51) Int. Cl. H04L 9/08

(52) U.S. Cl. CPC H04L 9/088

(57) ABSTRACT

An image processing apparatus of the present disclosure includes: an acquirer that acquires image data from an image; and one or more controllers that encrypt the image data based on a key, and outputs, as a file, the image data encrypted. The one or more controllers change an input condition for input of the key based on an encryption strength for encryption of the image data.

### CROSS-REFERENCE TO RELATED APPLICATION

The present application claims priority from Japanese Application JP2024-103191, the content of which is hereby incorporated by reference into this application.

### BACKGROUND OF THE INVENTION

### 1. Field of the Invention

The present disclosure relates to an image processing apparatus and a setting method.

### 2. Description of the Related Art

For example, as a related art, an encryption apparatus is known that ensures security by providing multiple levels of encryption strength for encryption of data.

### SUMMARY OF THE INVENTION

An object of the present disclosure is to ensure the security corresponding to the encryption levels in an image processing apparatus that can set a plurality of encryption levels, for example.

An image processing apparatus of the present disclosure includes: an acquirer that acquires image data from an image; and one or more controllers that encrypt the image data, based on a key and output, as a file, the image data encrypted. The one or more controllers change an input condition for input of the key, based on an encryption strength for encryption of the image data.

A setting method of the present disclosure includes: acquiring image data from an image; and encrypting the image data, based on a key and outputting, as a file, the image data encrypted. In the encrypting, an input condition for input of the key is changed based on an encryption strength for encryption of the image data.

According to the present disclosure, it is possible to ensure the security corresponding to the encryption levels in an image processing apparatus that can set a plurality of encryption levels, for example.

### BRIEF DESCRIPTION OF THE DRAWINGS

FIG. 1 is a perspective view for describing a general configuration in a first embodiment.

FIG. 2 is a diagram illustrating a configuration of an image forming apparatus in the first embodiment.

FIG. 3 is a diagram for describing a software configuration in the first embodiment.

FIG. 4A is a diagram illustrating an example of system setting information in the first embodiment, FIG. 4B is a diagram illustrating an example of job setting information in the first embodiment, and FIG. 4C is a diagram illustrating an example of encryption algorithm information in the first embodiment.

FIG. 5 is a diagram illustrating a processing procedure in the first embodiment.

FIG. 6 is a diagram illustrating a processing procedure in the first embodiment.

FIGS. 7A and 7B are diagrams illustrating exemplary operations in the first embodiment.

FIG. 8 is a diagram illustrating an exemplary operation in the first embodiment.

FIGS. 9A and 9B are diagrams illustrating exemplary operations in the first embodiment.

FIG. 10 is a diagram illustrating a processing procedure in a second embodiment.

FIG. 11 is a diagram illustrating a processing procedure in the second embodiment.

FIGS. 12A and 12B are diagrams illustrating exemplary operations in the second embodiment.

FIG. 13 is a diagram for describing a software configuration in a third embodiment.

FIG. 14 is a diagram illustrating a processing procedure in the third embodiment.

FIG. 15 is a diagram illustrating a processing procedure in the third embodiment.

FIG. 16 is a diagram illustrating a procedure of a password input process in the third embodiment.

FIG. 17 is a diagram illustrating a procedure of a password determination process in the third embodiment.

FIGS. 18A and 18B are diagrams illustrating exemplary operations in the third embodiment.

FIGS. 19A and 19B are diagrams illustrating exemplary operations in the third embodiment.

### DETAILED DESCRIPTION OF THE INVENTION

In general, image processing apparatuses perform various processes on an acquired image before outputting it. The image processing apparatus can store the output image in a storage, for example. The image processing apparatus may be provided in various apparatuses. Here, the image processing apparatus may be provided in an image forming apparatus such as a multifunction peripheral/printer/product (MFP) that can store a large number of images in a storage and send the output images through a telecommunication line, for example.

Here, in an image forming apparatus including an image processing apparatus, the image subjected to processing may contain confidential information, for example. In this case, encryption can be applied to the image data to ensure the confidentiality of the image data based on the image, for example. Various encryption algorithms for such encryption are known. In cases where the user requires a high level of confidentiality, it is necessary, for example, to select an encryption algorithm with a high encryption level (encryption strength).

However, when the user selects an encryption algorithm with higher encryption strength, there is a problem in that if the image forming apparatus does not control setting information necessary for encryption, such as password input rules, security corresponding to the higher encryption strength cannot be ensured.

An image processing apparatus that addresses such a problem will be described below with reference to the drawings and in accordance with the following embodiments. It is to be noted that the embodiments described below are merely examples for explaining the disclosure described in the claims, and the technical scope of the present disclosure is not limited to the descriptions of these embodiments.

### 1. First Embodiment

A first embodiment is described below. In the first embodiment, the following description is provided as an example. In the following embodiment, an example case is described in which the image processing apparatus of the present disclosure is applied to an image forming apparatus; however, the image processing apparatus of the present disclosure may also be applied to apparatuses other than image forming apparatuses.

### 1.1 General Configuration

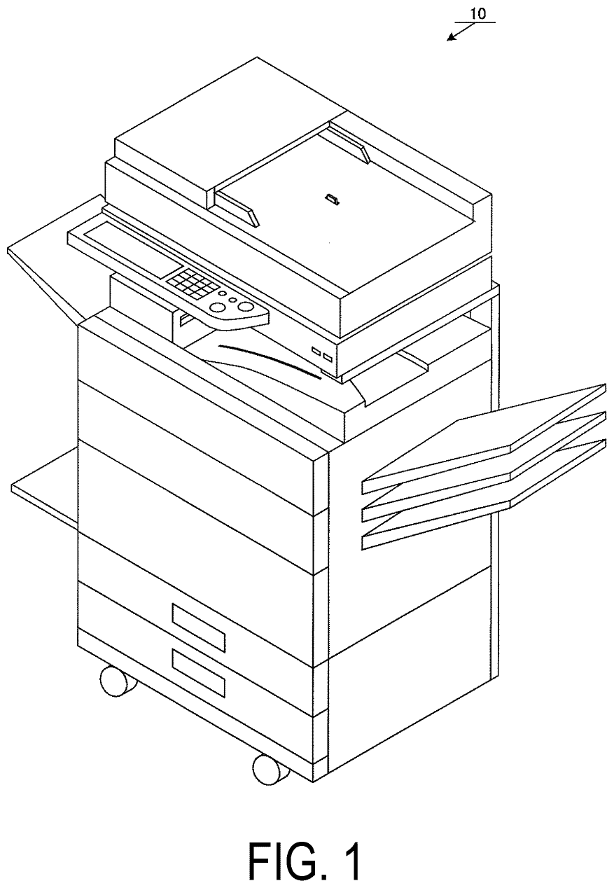

FIG. 1 is a perspective view illustrating an apparatus of an image forming apparatus 10.

The image forming apparatus 10 is, for example, multifunction peripherals, or apparatuses called MFP. For example, the image forming apparatus 10 can form images on paper, which is a recording medium, when a job (printing job) is executed. The image forming apparatus 10 can execute various jobs, including copy processing, fax processing, scan processing, and print processing.

Note that, in the scan processing, the image forming apparatus 10 can acquire images, store the acquired image in the storage apparatus or the like (scan-to-save), or send the image to a specified recipient using a network (NW) or the like (scan-to-send), for example.

In addition, the network (NW) for connecting the image forming apparatus 10 may be any type of communication line or communication system. For example, it is possible to use a wired or wireless local area network (LAN), a virtual local area network (VLAN), the Internet, a public switched network, mobile communications (such as 4G/5G/6G), or next-generation telecommunication networks.

### 1.2 Hardware Configuration

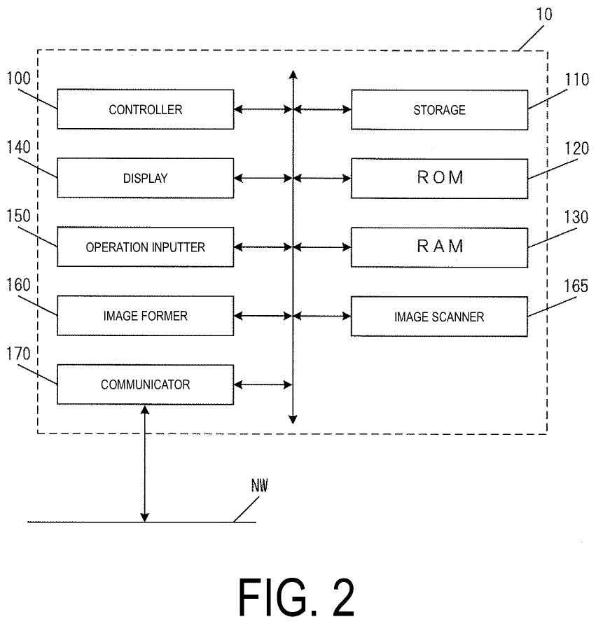

A hardware configuration of the image forming apparatus 10 is described below with reference to the drawings. FIG. 2 is a diagram illustrating an example of a hardware configuration of the image forming apparatus 10.

As illustrated in FIG. 2, the image forming apparatus 10 includes a controller 100, a storage 110 serving as a storage apparatus (storage), a read only memory (ROM) 120, a random access memory (RAM) 130, a display 140, an operation inputter 150, an image former 160, an image scanner 165, and a communicator 170.

The controller 100 controls the entirety of the image forming apparatus 10. The controller 100 executes various functions by reading and executing various programs stored in the storage apparatus (such as the storage 110 and the ROM 120). The controller 100 may be implemented with one or more control apparatuses/computation apparatuses (central processing unit (CPU), and system on a chip (SoC)). In addition, the controller 100 may be composed of one or more control circuits.

The storage 110 is a nonvolatile storage apparatus that can store programs and data. For example, it may be composed of one or more storage apparatuses such as a hard disk drive (HDD), and a solid state drive (SSD). In addition, the storage 110 may be an external apparatus such as a USB flash drive that can be connected to the image forming apparatus 10. In addition, the storage 110 may be a storage area provided on the cloud, for example.

The ROM 120 is a nonvolatile memory that can retain programs and data even when power is turned off.

The RAM 130 is a main memory that is used mainly when the controller 100 executes processes. The RAM 130 is a rewritable memory that can temporarily retain programs read from the storage 110 or the ROM 120, and data containing execution results.

The display 140 is a display device that can display various types of information and various screens such as an execution screen. The display 140 may be, for example, a liquid crystal display (LCD), an organic electro luminescence (organic EL) display, or an electrophoretic display. The display 140 also includes an interface to which a display apparatus can be connected. For example, it may be configured with an external display apparatus connected via high-definition multimedia interface (HDMI) (trade name), digital visual interface (DVI), or display port.

The operation inputter 150 is an operation apparatus that can receive operation input from the user. For example, it may be a software key displayed on a touch panel integrated with the display unit 140, or a hardware key such as an operation button. The operation inputter 150 may also be an operation apparatus such as a keyboard or a mouse. In addition, the operation inputter 150 may include an interface (for example, USB) to which an operation apparatus can be connected. For example, the image forming apparatus 10 may be connected to different operation apparatuses (such as a keyboard or a mouse) via the interface.

The image former 160 forms images on a recording sheet, for example. The image former 160 includes an image carrier, and forms images by forming toner images on the image carrier, and transferring, to the recording sheet, the toner images carried on the image carrier, for example. The image former 160 may be configured as an image forming apparatus such as a printer. The image former 160 may also electronically form an image as an image file.

The image scanner 165 reads a document (image), and outputs it as image data. The image scanner 165 is a scanner, and may be a reading apparatus using a charge coupled device (CCD), a contact image sensor (CIS), or a complementary metal-oxide-semiconductor (CMOS) image sensor, for example.

The communicator 170 is a communication interface for communicating with other apparatuses. For example, it may be a network interface that supports wired or wireless connections. In the present embodiment, communication with other apparatus is enabled via a network (NW).

### 1.3 Software Configurations

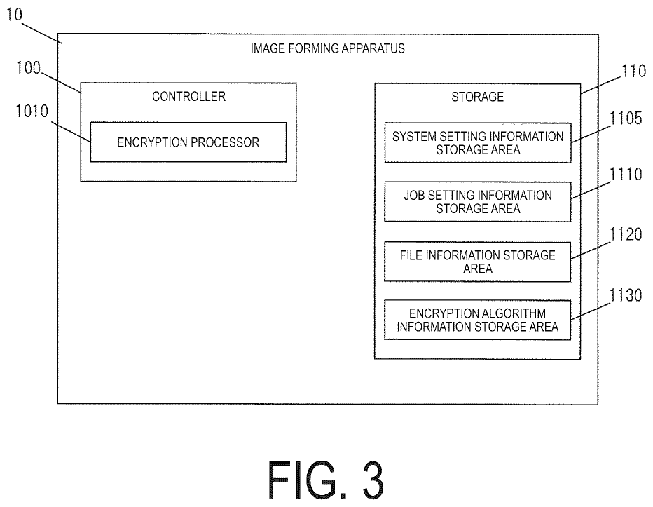

A main software configuration in the image forming apparatus 10 is described below with reference to FIG. 3. Note that, the software configuration illustrated in FIG. 3 mainly illustrates the components necessary in the present embodiment, and other components are omitted.

For example, the controller 100 can implement an encryption processor 1010 by reading and executing programs stored in the storage (the storage 110, the ROM 120).

The encryption processor 1010 executes encryption processing on the acquired image data, for example. Here, encryption refers to a process of transforming the acquired image data to prevent third parties from deciphering it. The encryption processor 1010 may encrypt the image data using an encryption algorithm such as advanced encryption standard (AES), rivest cipher 4 (RC4), and data encryption standard (DES), for example.

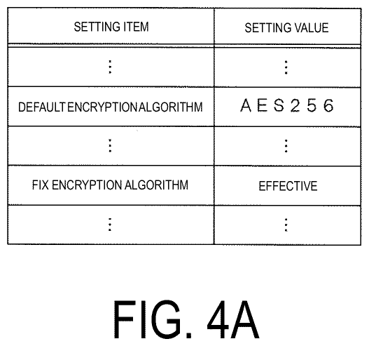

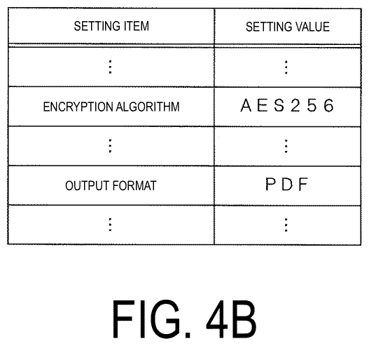

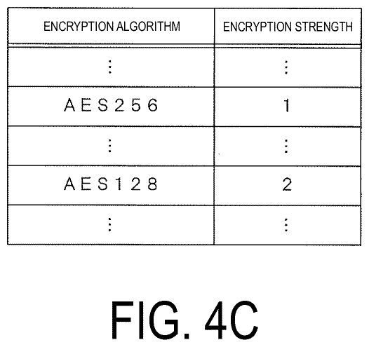

The storage 110 allocates a system setting information storage area 1105 for storing system setting information. The system setting information is setting information required for operating the image forming apparatus 10, for example. Here, an example of the system setting information stored in the system setting information storage area 1105 is described with reference to FIG. 4A. The system setting information storage area 1105 stores a setting value (for example, “AES 256”) and a setting item (for example, “default encryption algorithm”) of setting information required for operating the image forming apparatus 10.

In addition, the storage 110 allocates a job setting information storage area 1110 for storing the job setting information. The job setting information is setting information related to the job to be executed by the image forming apparatus 10. Here, an example of the job setting information stored in the job setting information storage area 1110 is described with reference to FIG. 4B. The job setting information storage area 1110 stores the setting value (for example, “AES 256”) and the setting item (for example, “encryption algorithm”) of the setting information related to the scan job of the image forming apparatus 10. The setting information related to a job is, for example, setting information related to a scan job. Specifically, it includes information on the job type (here, the job type indicates the kind of job executed by the image forming apparatus 10, such as scan-to-save or scan-to-send in the case of a scanning-related job), information on image reading conditions (for example, resolution, color information such as monochrome or color, compression ratio, and the like), information indicating the file format used when outputting image data as a file (for example, JPG format, GIF format, TIFF format, PDF format, and the like), and information related to the encryption processing of the image.

Further, the storage 110 allocates a file information storage area 1120 for storing file information. The file information is information related to the file that is output when the image forming apparatus 10 outputs a file. For example, it may be information related to the format when the image forming apparatus 10 outputs the acquired image. The format of the file to be output may be file formats used in generally-used information processing apparatuses, for example. In addition, the file information may also store a file name, information related to the image data, and additional information including attributes, for example.

In addition, the storage 110 allocates an encryption algorithm information storage area 1130 for storing encryption algorithm information. The encryption algorithm information is information in which the encryption algorithms that can be selected by the image forming apparatus 10 are grouped according to encryption strength, for example. In the present embodiment, the encryption strength of the group having strong encryption strength is defined as a first strength, for example. Further, a group having encryption strength weaker than that of the group belonging to the first strength is defined as a group belonging to a second strength, for example. As a method of grouping according to the encryption strength, the grouping may be based on the key length of a key (encryption password) that can be stored by the encryption algorithm, or the types of characters that can be stored, for example. The encryption algorithm information stores the encryption algorithm and the corresponding encryption strength.

Note that, the encryption algorithm of the group belonging to the first strength may be AES 256-bit, for example. The encryption algorithm of the group belonging to the second strength may be AES 128-bit or RC4 128-bit, for example.

Here, an example of the encryption algorithm information stored in the encryption algorithm information storage area 1130 is described with reference to FIG. 4C. An encryption strength (for example, “1”) and a selectable encryption algorithm (for example, “AES 256”) that can be selected by the image forming apparatus 10 are stored. Here, the encryption strength may be information including “1”, which indicates the group belonging to the first strength, and “2”, which indicates the group belonging to the second strength, for example.

### 1.4 Processing Procedure

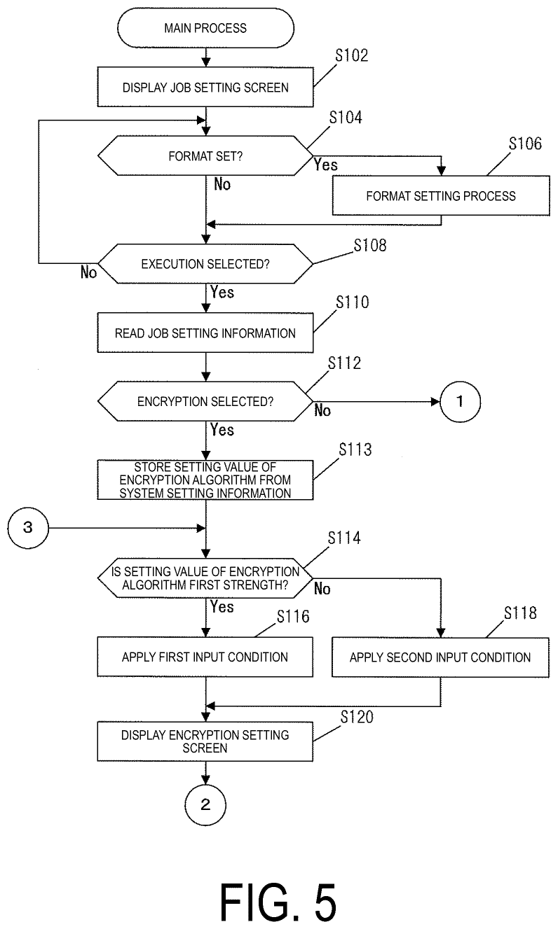

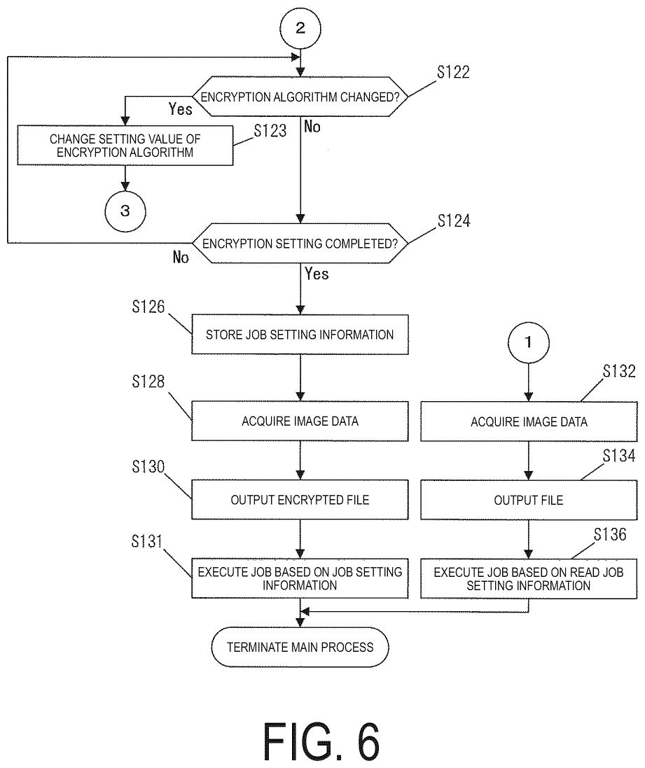

A processing procedure in the present embodiment is described below with reference to FIGS. 5 and 6. FIGS. 5 and 6 are diagrams illustrating a procedure in an initial setting (default) process of the present embodiment. Note that, the configurations described in FIG. 2 or 3 may execute processes of respective steps.

First, the controller 100 displays a job setting screen (S102). Here, the job setting screen may be displayed on the display 140 as a display screen that displays the setting value and the setting item related to a scan processing (scan job) that can be executed by the image forming apparatus 10 and allows the setting value to be changed, for example.

Subsequently, when setting the format for outputting image data as a file, the controller 100 performs a format setting process (S104; Yes→S106). Here, the setting of the format refers to newly setting a format for storing image data as a file, changing the format from the initial setting, or changing it from an already set format, for example. The controller 100 may determine that the format is to be set when the user selects an operation button for setting the format included in the job setting screen, for example.

In addition, in the format setting process, a format setting screen may be displayed, for example. As the format setting screen, the controller 100 may display, on the display 140, a display screen that allows selection of the format for outputting image data, and a display screen that allows selection of whether to execute the encryption process, for example.

Here, when the user has made a selection to execute the encryption process, the controller 100 stores execution of the encryption process in the job setting information to be stored in the job setting information storage area 1110, for example.

Subsequently, the controller 100 determines whether the user has selected an operation of executing a job (S108). Note that, the controller 100 executes the process S108 even when the format for outputting image data as a file is not set (S104; No→S108). The controller 100 may determine whether the user has selected an operation of instructing the execution of a job, based on whether the user has selected a key (for example, execution key) for instructing an operation of executing a job, for example.

The controller 100 reads the job setting information when it determines that the user has selected an operation of executing a job (S108; Yes→S110). The controller 100 may temporarily read out, into the RAM 130, the information on the setting item and setting value of the job setting information stored in the job setting information storage area 1110, for example. On the other hand, when the controller 100 determines that an operation of executing a job has not been selected, the controller 100 may repeat the process from S104 again (S108; No→S104). In addition, in the controller 100, other settings (for example, the setting in job execution and the like) may be changed by the user before an operation of executing a job is selected.

Next, the controller 100 determines whether the encryption of the file is selected (S112). For example, when file encryption is stored in the job setting information read from the job setting information storage area 1110, the controller 100 may determine that file encryption has been selected. When the controller 100 determines that file encryption has been selected, the controller 100 may set it to the initial encryption algorithm. For example, the controller 100 may acquire the setting value of the default encryption algorithm from the system setting information, and store it as the setting value of the encryption algorithm of the read job setting information (S112; Yes→S113). In addition, the initial value of the encryption algorithm may be in an unselected state.

Next, the controller 100 determines whether the setting value of the read encryption algorithm is the first strength (S114). Here, as the method of determining whether the encryption strength of the encryption algorithm is the first strength, the controller 100 may compare the encryption algorithm of the read job setting information and the encryption algorithm stored in the encryption algorithm information storage area 1130, and determine that it is the first strength when the encryption algorithm stored in the job setting information is in the group belonging to the first strength.

When the controller 100 determines that the encryption strength of the encryption algorithm is the first strength, the controller 100 applies a first input condition to the condition for input of the password (S114; Yes→S116). Here, the first input condition refers to an input condition adapted to the key length of an encryption password that can be set for the encryption algorithm of the group belonging to the first strength, or to the types of characters that can be stored as the encryption password, for example. Note that as the first input condition, in the case where the encryption algorithm is AES 256-bit, the key length may be set to up to 127 characters, and more preferably, from 33 to 127 characters, for example.

On the other hand, when the controller 100 determines that the encryption strength of the encryption algorithm for encrypting the file is not the first strength, the controller 100 applies a second input condition to the input condition for the encryption password (S114; No→S118). Here, the second input condition refers to, similarly to the first input condition, an input condition adapted to the encryption password that can be stored by the encryption algorithm of the group belonging to the second strength. For example, as the second input condition, in the case where the encryption algorithm is AES 128-bit, the key length may be set to up to 32 characters. More preferably, the key length may be from 1 to 32 characters.

Subsequently, the controller 100 displays an encryption setting screen (S120). As the encryption setting screen, the controller 100 may display, on the display 140, a display screen that includes the setting item and the setting value related to encryption in the read job setting information, and allows the setting value to be changed and the scan job to be executed, for example.

Here, the controller 100 may execute a process that prohibits inputs that do not match either the first input condition or the second input condition for the encryption password for the file to be encrypted and output, for example.

Next, the controller 100 determines whether there is a change in setting value of the encryption algorithm (the encryption strength related to the encryption) displayed on the encryption setting screen (S122), for example. When the controller 100 determines that there is a change in the encryption strength (encryption algorithm), the controller 100 changes the setting value of the encryption algorithm of the read job setting information (S122; Yes→S123), for example. Subsequently, the controller 100 executes the process S114 again.

On the other hand, when the controller 100 determines that there is no change in the encryption strength, the controller 100 determines whether the setting of the encryption has been completed (S122; No→S124). Here, as the method of determining whether the setting of the encryption has been completed, the setting of the encryption may be determined to be completed when a scan job execution button (for example, a save button B106) displayed on the encryption setting screen is selected, for example.

When the controller 100 determines that the setting of the encryption has been completed, the controller 100 stores the setting value for which encryption setting has been made as the job setting information (S124; Yes→S126). On the other hand, when the controller 100 determines that the encryption setting has not been completed, the controller 100 determines whether there is a change in the encryption strength (S124; No→S122).

Next, the controller 100 acquires image data (S128). The controller 100 acquires the image data from the image scanner 165 on the basis of the setting information related to the image reading condition included in the job setting information stored in the job setting information storage area 1110, for example. The controller 100 may temporarily store the acquired image data in the RAM 130 or the like.

Subsequently, the controller 100 encrypts the image data, and outputs the encrypted file (S130). The controller 100 executes encryption on the image data acquired by the encryption processor 1010 in accordance with the encryption algorithm stored in the job setting information storage area 1110, and outputs it as an encrypted file, for example. Next, the controller 100 executes the job on the basis of the job setting information stored in the job setting information storage area 1110 (S131).

For example, when executing a scan-to-send job, the controller 100 sends the encrypted file to the destination designated by the job setting information in accordance with the job setting.

Note that, when the controller 100 determines that file encryption has not been selected, the controller 100 acquires the image data from the image scanner 165 on the basis of the setting information related to the image reading condition included in the job setting information (S112; No→S132). Subsequently, the controller 100 outputs the image data as a file in the format designated by the job setting information (S134). Next, the controller 100 executes the job on the basis of the read job setting information (S136).

For example, when executing a scan-to-save job, the controller 100 saves the output file in the storage destination of the file information storage area 1120 designated by the job setting information.

### 1.5 Exemplary Operations

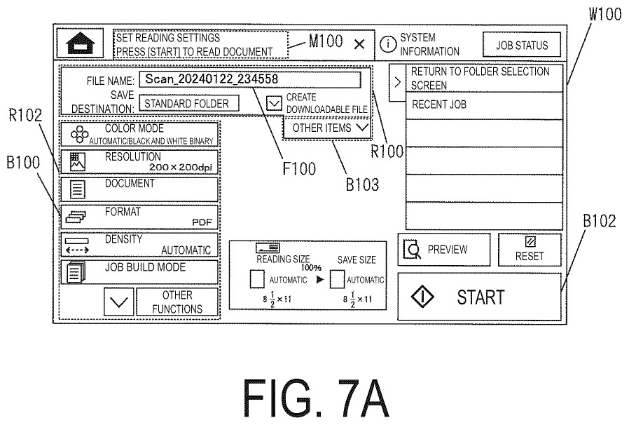

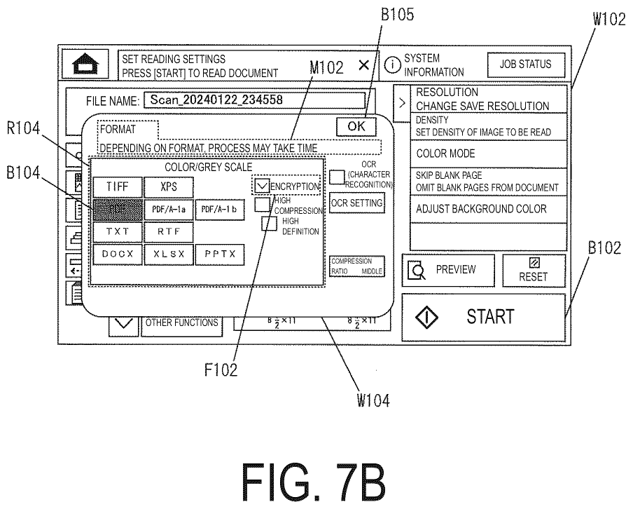

FIGS. 7A and 7B are diagrams illustrating examples of a display screen including a message that is displayed to the user as an operation result of the image forming apparatus 10 in the present embodiment.

FIG. 7A is a diagram illustrating an example of a display screen W100 displayed on the display 140 of the image forming apparatus 10. The display screen W100 is a diagram illustrating an example of a job setting screen (display screen) including a message that is displayed to the user when the image forming apparatus 10 executes a scan job, for example. The display screen W100 displays a message M100 stating “SET READING SETTINGS. PRESS [START] TO READ DOCUMENT”, and a start button B102. Further, in an area R100 of the display screen W100, a file name input form F100, file save destination, and a check box for creating a downloadable file are displayed. In addition, in an area R102 of the display screen W100, a selectable format button B100, and buttons for various settings related to other scan jobs (color mode, resolution, document, density, job build mode) are displayed. Further, the display screen W100 displays an other items button B103.

Here, the user selects the file name input form F100, and enters a file name “Scan_20240122_234558”. Note that, the entry of file name is not mandatory, and the controller 100 may display an automatically generated file name in the file name input form F100 as an initial value, for example. Next, when the user selects the start button B102 serving as an execution key, the controller 100 executes scanning on the basis of the job setting information stored in the job setting information storage area 1110, and saves a non-encrypted file in the designated folder. Note that, in FIG. 7A, the file information can be changed. Specifically, when the button displayed in the area R102 is selected, the file information and the like can be changed in accordance with the button. For example, when the user selects the format button B100, the controller 100 displays a display screen W102 and a window display (format setting screen) W104 of FIG. 7B. In addition, when the user selects the other items button B103, for example, the area R100 may pull down to display additional settings that are not displayed there.

FIG. 7B is a diagram illustrating an example of the display screen W102 displayed on the display 140 of the image forming apparatus 10, and the window display W104 superimposed on the display screen W102. On the display screen W102, for example, the window display W104 as a dialog, and the start button B102 serving as an execution key are displayed.

Here, the window display W104 displays a message M102 stating “FORMAT: DEPENDING ON FORMAT, PROCESSING MAY TAKE TIME”, and an OK button B105. Further, in an area R104 of the window display W104, selection buttons for selecting various types of file formats, a button indicating the format of the file identified “portable document format PDF) button B104”, and an encryption input form F102 are displayed.

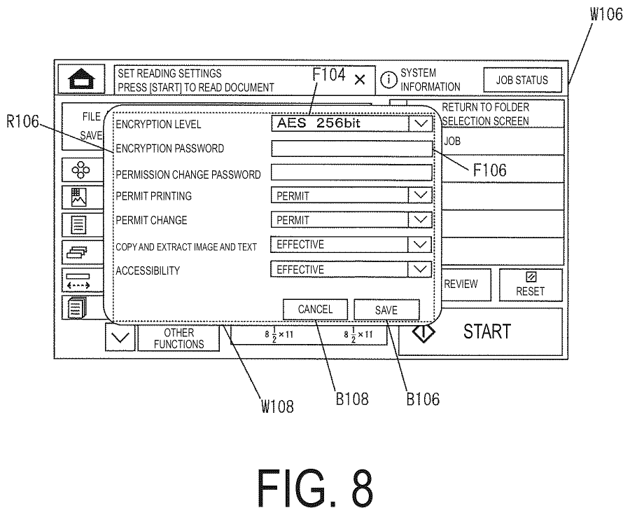

Here, when the user selects the PDF button B104, the controller 100 sets PDF to the format of the file to be output to the file information storage area 1120. In addition, when the user selects the encryption input form F102, the controller 100 indicates a check mark in the check box displayed on the encryption input form F102, whereas when the user selects the OK button B105, the controller 100 closes the window display W104, stores execution of an encryption process in the job setting information storage area 1110, terminates the window display W104, and indicates a character string (for example, encrypted PDF) representing the format setting information on the format button B100. The format setting information displayed on the format button B100 is not limited to character strings, and may be an icon image or the like indicating the format setting information. Then, when the user selects the start button B102, the controller 100 displays a display screen W106 and a window display (the encryption setting screen) W108 of FIG. 8.

FIG. 8 is a diagram illustrating an example of the display screen W106 displayed on the display 140 of the image forming apparatus 10, and the window display W108 superimposed on the display screen W106. On the display screen W106, for example, the window display W108 is displayed as a dialog. In an area R106 of the window display W108, an encryption level input form F104, an encryption password input form F106, the save button B106 serving as an execution button for instructing execution of a job, a cancel button B108 for instructing cancellation of encryption setting, and input forms for other encryption settings (a permission change password, permit printing, permit change, copy and extract image and text, and accessibility) are displayed.

Note that, the controller 100 may display AES 256-bit as the initial value of the encryption level in the encryption level input form F104 on the basis of the system setting information. In addition, if there is no initial value, the controller 100 may display blank or predetermined marks.

In addition, the controller 100 may display a button by changing the display message in accordance with the job type as the execution button. For example, it displays the save button B106 in the case where the job type to be stored in the job setting information is scan-to-save. In the case where the job type to be stored in the job setting information is scan-to-send, the controller 100 displays a send button instead of the save button B106. The controller 100 may also change the display mode of the execution button according to the state prior to the transition to the screen that displays the execution button. In the present embodiment, although the execution button displays messages such as “Save” or “Send” depending on the job type, it may be displayed using different shapes (different button designs), or the same wording (for example, “Execute” or “OK”) may be displayed regardless of the job type.

Here, when the user selects the encryption level input form F104, the controller 100 displays a pull-down menu for the encryption level input form F104 to display encryption algorithms such as AES 128-bit and RC4 128-bit in addition to AES 256-bit, for example. Next, it is assumed that the user has selected the encryption password input form F106 and input the encryption password. Here, for example, when the encryption level selected in the encryption level input form F104 is AES 256-bit, the controller 100 allows entry of up to 127 characters in the encryption password input form F106.

Next, it is assumed that the user has selected AES 128-bit in the encryption level input form F104. Then, the controller 100 allows entry of up to 32 characters in the encryption password input form F106, and prohibits entry of 33 characters or more. Then, when the user selects the save button B106, the controller 100 executes scanning on the basis of the job setting information stored in the job setting information storage area 1110, and saves the encrypted file in the designated folder. Note that, when the user selects the cancel button B108, the controller 100 returns to and displays the previous state. For example, the controller 100 may close the window display W108 of FIG. 8 to display only the display screen W106, or may display the display screen W102 of FIG. 7B in the state immediately after the OK button B105 is selected.

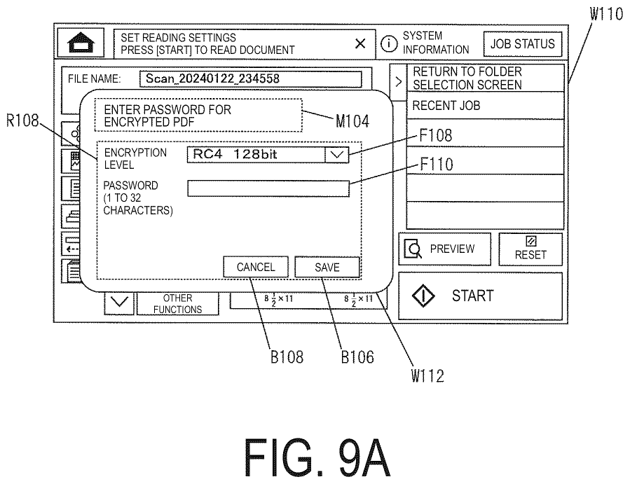

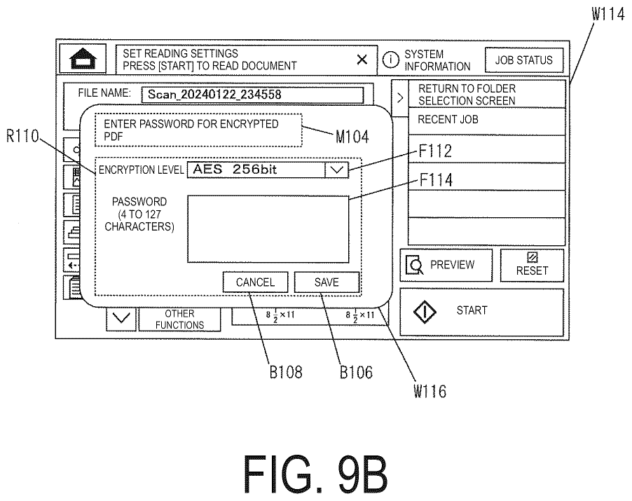

FIG. 9A is a diagram illustrating an example of a display screen W110 displayed on the display 140 of the image forming apparatus 10 instead of the display screen W106 and the window display W108 illustrated in FIG. 8, and a window display (the encryption setting screen) W112 superimposed on the display screen W110. The window display W112 is a diagram illustrating an example of the encryption setting screen (display screen) including a message that is displayed to the user when the user selects the start button B102 on the display screen W102 in which the window display W104 has been terminated and a character string (for example, encrypted PDF) representing the format setting information is displayed on the format button B100, and RC4 128-bit is selected as the initial value of the encryption algorithm, for example. On the display screen W110, the window display W112 is displayed as a dialog, for example. The window display W112 displays a message M104 stating “ENTER PASSWORD FOR ENCRYPTED PDF”. Further, in an area R108 of the window display W112, an encryption level input form F108, a password (1 to 32 characters) input form F110, the save button B106, and the cancel button B108 are displayed.

Here, when the user selects the encryption level input form F108, the controller 100 displays a pull-down menu for the encryption level input form F108, and displays encryption algorithms such as AES 256-bit and AES 128-bit in addition to RC4 128-bit. Next, it is assumed that the user has selected the password (1 to 32 characters) input form F110 and input the encryption password. Here, since RC4 128-bit has been selected in the encryption level input form F108, the controller 100 allows entry of 1 to 32 characters in the encryption password input form F110, and prohibits entry of less than 1 character and more than 32 characters, for example.

Next, it is assumed that the user has selected AES 256-bit in the encryption level input form F108. Then, the controller 100 displays a display screen W114 and a window display W116 of FIG. 9B. Then, when the user selects the save button B106 after inputting the encryption password, the controller 100 executes scanning on the basis of the job setting information stored in the job setting information storage area 1110, and saves the encrypted file in the designated folder. Note that, when the user selects the cancel button B108, the controller 100 returns to and displays the previous state. For example, the controller 100 may display the display screen W110 and the window display W112 superimposed on the display screen W110 of FIG. 9A.

FIG. 9B is also a diagram illustrating an example of the display screen W114 displayed on the display 140 of the image forming apparatus 10 instead of the display screen W106 illustrated in FIG. 8, and the window display (the encryption setting screen) W116 superimposed on the display screen W114. In this case, the display screen W114 is a diagram illustrating an example of the encryption setting screen (display screen) including a message that is displayed to the user when the user selects the start button B102 on the display screen W102 in which the window display W104 has been terminated and a character string (for example, encrypted PDF) representing the format setting information is displayed on the format button B100, and AES 256-bit is selected as the initial value of the encryption algorithm, for example. On the display screen W114, the window display W116 is displayed as a dialog, for example. On the window display W116, the message M104 stating “ENTER PASSWORD FOR ENCRYPTED PDF” is displayed. Further, in an area R110 of the window display W116, an encryption level input form F112, a password (4 to 127 characters) input form F114, the save button B106, and the cancel button B108 are displayed.

Here, when the user selects the encryption level input form F112, the controller 100 displays a pull-down menu for the encryption level input form F112 to display encryption algorithms such as AES 128-bit and RC4 128-bit in addition to AES 256-bit. Next, it is assumed that the user has selected the password (4 to 127 characters) input form F114 and input the encryption password. Here, since AES 256-bit has been selected in the encryption level input form F112, the controller 100 allows entry of 4 to 127 characters, and prohibits entry of 3 or fewer characters and 128 or more characters in the encryption password input form F110, for example.

Next, it is assumed that the user has selected RC4 128-bit in the encryption level input form F112. Then, the controller 100 displays the display screen W110 and the window display W112 of FIG. 9A. Then, when the user selects the save button B106 after inputting the encryption password, the controller 100 executes scanning on the basis of the job setting information stored in the job setting information storage area 1110, and saves the encrypted file in the designated folder. Note that, when the user selects the cancel button B108, the controller 100 returns to and displays the previous state. For example, the controller 100 may display the display screen W114, and the window display W116 superimposed on the display screen W114 of FIG. 9B.

In FIGS. 9A and 9B, when the user changes the encryption level in the state where the password has been entered in the password input forms F110 and F114, the controller 100 may cancel the entered password in the password input forms F110 and F114, for example. Alternatively, in the case where the password that has already been input satisfies the input condition for the encryption level after the change, the controller 100 may use it as it is without cancelling it, for example.

In the present embodiment, the format setting screen and the encryption setting screen are displayed as dialog windows on the job setting screen. Here, each setting screen may be displayed on the display 140 by transitioning from the job setting screen, or may be displayed on the display 140 as a pull-down menu, for example. In addition, the encryption setting screen displays at least the encryption level and the password input form, for example.

### 1.6 Effects, etc.

In this manner, according to the present disclosure, the input condition for the encryption password can be changed to the optimum input condition in accordance with the encryption strength of the encryption algorithm selected by the user. Accordingly, the controller 100 can control the input rule for the encryption password and the like, and thus the security corresponding to the encryption strength of the encryption algorithm selected by the user can be ensured.

In addition, by displaying the setting screen for the encrypted PDF after the scan start instruction, it becomes possible to separate the settings related to the encrypted PDF from other settings, thereby enabling more simplified operation. Further, by controlling the number of characters in the encryption password in accordance with the encryption level (encryption strength), an encryption password with a security strength appropriate for the encryption level can be set.

### 2. Second Embodiment

Now a second embodiment is described below. In the second embodiment, a predefined value may be set to the encryption algorithm, and the operation of changing the encryption algorithm on the encryption setting screen may be prohibited.

In the second embodiment, descriptions of the hardware and software configurations that are the same as those in the first embodiment are omitted, and the differences from the first embodiment are mainly described.

### 2.1 Processing Procedure

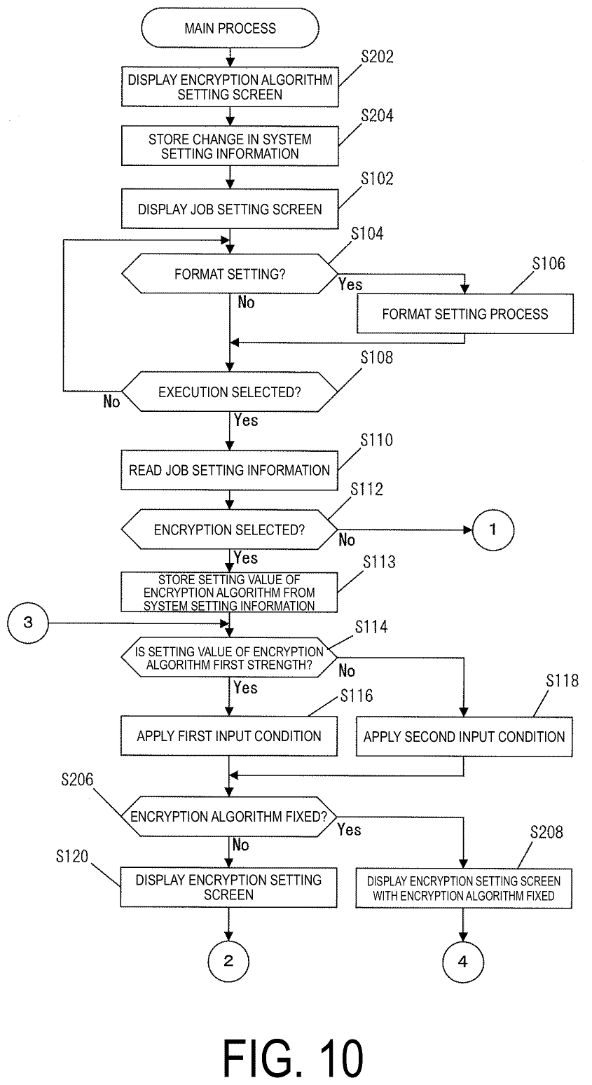

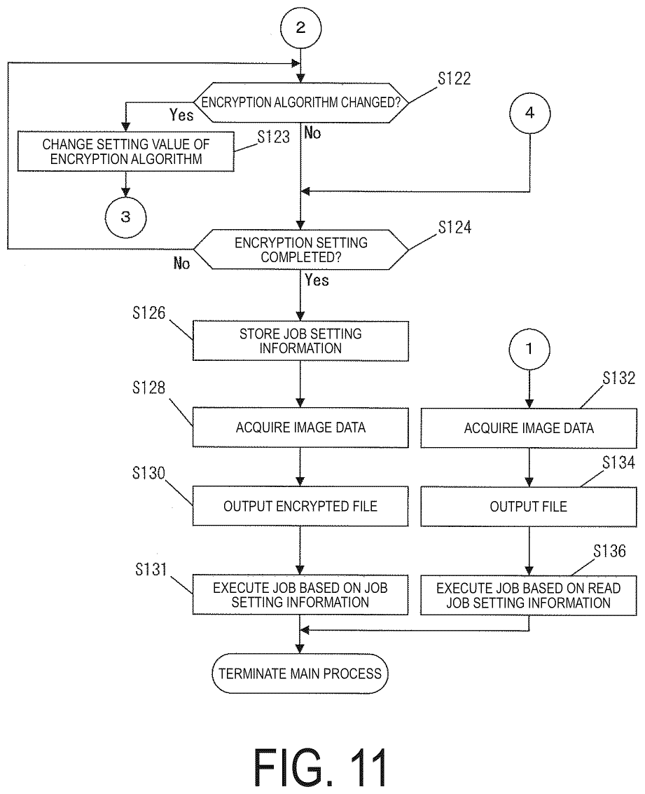

FIGS. 10 and 11 are diagrams illustrating a processing procedure in the present embodiment. FIG. 10 is a diagram that replaces FIG. 5 of the first embodiment. S202 and S204 are executed before S102 of FIG. 5, and S206 and S208 are executed after S116 or S118 of FIG. 5.

First, the controller 100 displays the encryption algorithm setting screen (S202). Here, the encryption algorithm setting screen is a display screen where a predefined (default) encryption algorithm can be selected, for example. Further, the encryption algorithm setting screen may allow a setting to enable or disable the fixing of the encryption algorithm (prohibition of change operations), for example.

Next, for example, the controller 100 stores a change related to the encryption algorithm made by the user on the encryption algorithm setting screen as a change of the system setting information in the system setting information storage area 1105 (S204).

In addition, for example, the controller 100 determines whether the encryption algorithm is fixed from the system setting information (S206). Here, for example, the controller 100 may determine that the encryption algorithm is fixed and cannot be selected or changed when the system setting information stores that the prohibition of change operations for the encryption algorithm is enabled, or when the default setting value of the encryption algorithm stores a specific value (for example, AES 256-bit).

When the controller 100 determines that the encryption algorithm is fixed, the controller 100 displays, on the display 140, the encryption setting screen where the operation of changing the setting value of the encryption algorithm is prohibited (S206; Yes→S208). For example, the controller 100 may fix the selection field for the setting value of the encryption algorithm or display it in a grayed-out state so that it cannot be selected.

Then, the controller 100 determines whether the setting of the encryption has been completed (S208→S124).

On the other hand, when the controller 100 determines that the encryption algorithm is not fixed, the controller 100 displays the encryption setting screen (S206; No→S120).

### 2.2 Exemplary Operations

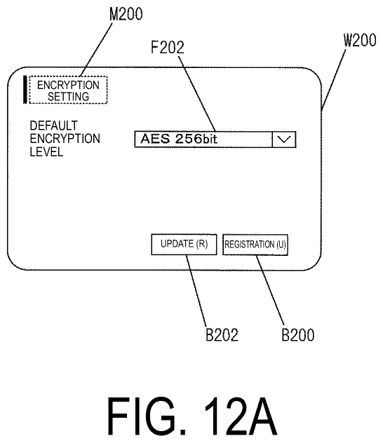

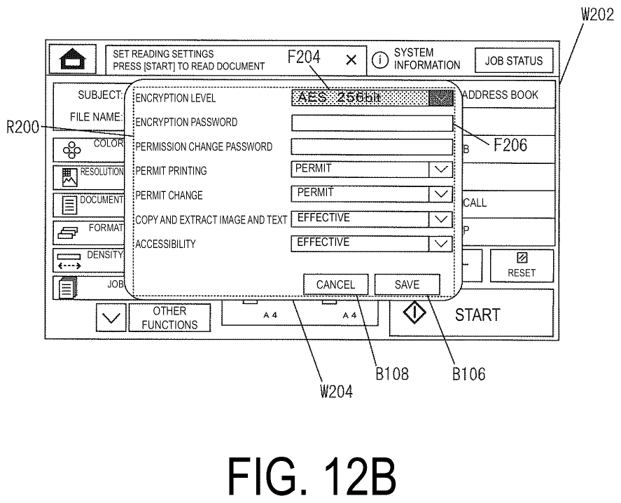

FIGS. 12A and 12B are diagrams illustrating examples of a display screen including a message that is displayed to the user as an operation result of the image forming apparatus 10 in the present embodiment.

FIG. 12A is a diagram illustrating an example of a display screen W200 displayed on the display 140 of the image forming apparatus 10. The display screen W200 is a diagram illustrating an example of the encryption algorithm setting screen (display screen) including a message that is displayed to the user for setting a predefined (default) value of the encryption algorithm before the image forming apparatus 10 performs a scan job, for example. The display screen W200 displays a message M200 stating “ENCRYPTION SETTING”, a default encryption level input form F202, a registration (U) button B200, and an update (R) button B202.

Here, when the user selects the default encryption level input form F202, the controller 100 displays a pull-down menu for the default encryption level input form F202, and displays encryption algorithms such as AES 128-bit and RC4 128-bit in addition to AES 256-bit, for example. Then, when the user selects the update (R) button B202, the controller 100 stores AES 256-bit displayed in the default encryption level input form F202 as a default encryption level in the system setting information storage area 1105. On the other hand, when the user selects the registration (U) button B200, the controller 100 stores the default encryption level as with the update (R) button B202, closes the display screen W200 of FIG. 12A, and displays the home screen, the job setting screen and the like, for example.

FIG. 12B is a diagram illustrating an example of a display screen W202 displayed on the display 140 of the image forming apparatus 10 and a window display W204 superimposed on the display screen W202. The display screen W202 is a diagram illustrating an example of the encryption setting screen (display screen) including a message that is displayed to the user when the user selects the start button B102 serving as an execution key on the display screen W102 in which the window display W104 of FIG. 7B has been terminated and a character string (for example, encrypted PDF) representing the format setting information is displayed on the format button B100, for example. On the display screen W202, the window display W204 is displayed as a dialog, for example. In an area R200 of the window display W204, an encryption level input form F204, an encryption password input form F206, the save button B106, the cancel button B108, and input forms for other encryption settings (a permission change password, permit printing, permit change, copy and extract image and text, and accessibility) are displayed. Note that, the window display W204 may or may not optionally display one or more items in the input forms for other encryption settings. Note that, the window display W204 of FIG. 12B may be displayed as with the window display W116 of FIG. 9B, for example.

Here, when the user selects the encryption level input form F204, the controller 100 prohibits the operation of changing the encryption level input form F204, and therefore does not display options other than AES 256-bit, which is the default setting. Next, it is assumed that the user has selected the encryption password input form F206 and input the encryption password. Here, since the encryption level selected in the encryption level input form F204 is AES 256-bit and the changing operation is prohibited, the controller 100 allows entry of 4 to 127 characters in the encryption password input form F106, for example. Then, when the user selects the save button B106, the controller 100 executes scanning on the basis of the job setting information stored in the job setting information storage area 1110, and saves an encrypted file in the save destination (folder) designated by the user, for example. Note that, when the user selects the cancel button B108, the controller 100 displays the display screen W100 of FIG. 7A.

### 2.3 Effects, etc.

In this manner, the controller 100 can determine the predefined encryption algorithm and execute encryption. This makes it unnecessary for the user to determine the encryption algorithm for each scan job, thereby reducing the amount of work required.

In addition, the user can set the encryption level in advance, and perform encryption using that encryption level.

### 3. Third Embodiment

Now a third embodiment is described below. In this embodiment, for example, in the case of scan-to-send, the encryption setting screen is always displayed, whereas in the case of scan-to-save where a confidential attribute and a confidential password (second password) are added to the file, the second password is set as the first password, thereby omitting the display of the encryption setting screen.

In the third embodiment, descriptions of the hardware and software configurations that are the same as those in the first embodiment are omitted, and the differences from the first embodiment are mainly described.

### 3.1 Software Configurations

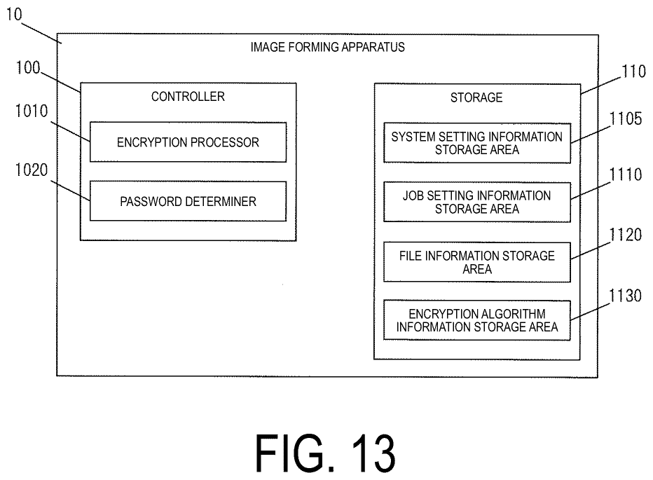

Main software configurations in the image forming apparatus 10 are described below with reference to FIG. 13. Note that, the software configurations illustrated in FIG. 13 are main configurations required in the present embodiment, and other configurations are omitted.

For example, the controller 100 can read and execute programs stored in the storage (the storage 110 and the ROM 120), and implement a password determiner 1020.

The password determiner 1020 determines whether the password satisfies the password policy (restriction conditions) serving as the encryption password. Here, the restriction conditions refer to conditions imposed on the characters that constitute the password. Specifically, the conditions may include the following:
a predetermined number or more of types of characters are used in the entered password;
the number of characters in the entered password falls within a range of a predetermined number of characters;
the entered password does not contain any unusable characters;
   and the like.

In the present embodiment, for an encryption algorithm belonging to the first strength, the password determiner 1020 may determine that the password satisfies the password policy when the character length of the password falls within the range permitted for the first strength. Preferably, the password determiner 1020 may determine that the password satisfies the password policy when the character length is 4 to 127 characters. For an encryption algorithm belonging to the second strength, the password determiner 1020 may determine that the password satisfies the password policy when the character length of the password falls within the range permitted for the second strength. Preferably, the password determiner 1020 may determine that the password satisfies the password policy when the character length is 1 to 32 characters.

### 3.2 Processing Procedure

### 3.2.1 Main Process

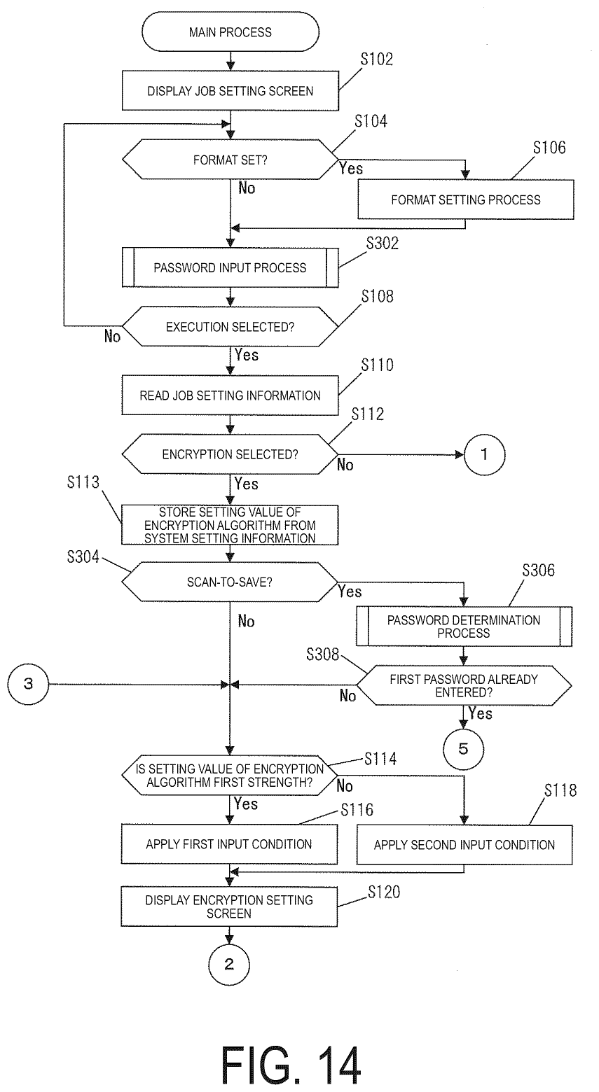

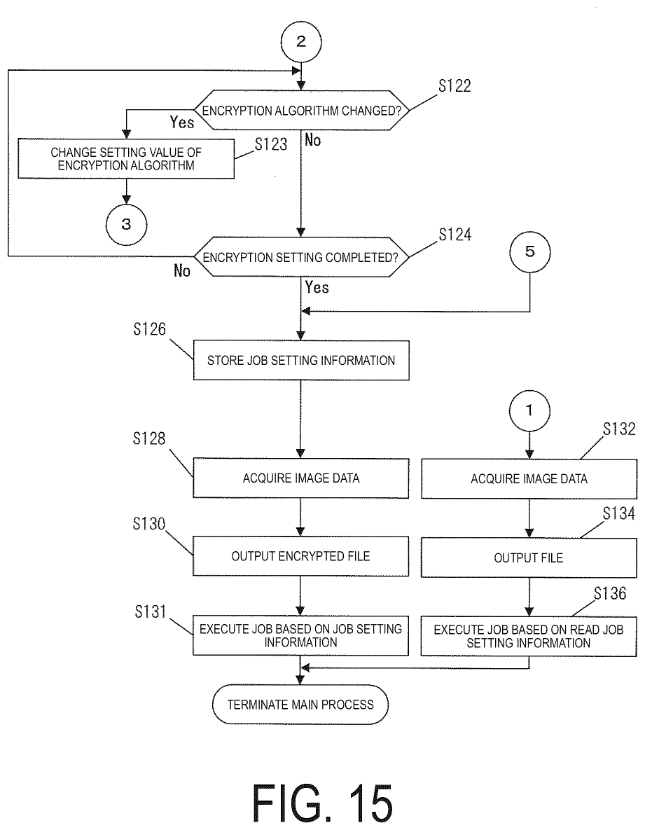

FIGS. 14 and 15 are diagrams illustrating the main processing procedure in the present embodiment. FIG. 14 is a diagram that replaces FIG. 5 of the first embodiment. S302 is executed between S104 and S108 of FIG. 5, and S304, S306 and S308 are executed between S113 and S114 of FIG. 5. In addition, FIG. 15 is a diagram that replaces FIG. 6 of the first embodiment.

First, the controller 100 executes a password input process (S302). The password input process will be described later. In addition, the controller 100 determines whether the type (job type) of the job to be executed stored in the read job setting information is scan-to-save (S304), for example. Here, when the controller 100 determines that the job type is not scan-to-save, the controller 100 determines whether the encryption strength of the encryption algorithm is the first strength (S304; No→S114).

On the other hand, when the controller 100 determines that the job type is scan-to-save, the controller 100 executes the password determination process (S304; Yes→S306). The password determination process will be described below. Subsequently, the controller 100 determines whether the first password is stored (already entered) in the read job setting information (S308).

When the controller 100 determines that the first password has already been entered, the controller 100 stores the job setting information (S308; Yes→S126). On the other hand, when the controller 100 determines that the first password has not already been entered, the controller 100 determines whether the encryption strength of the encryption algorithm is the first strength (S308; No→S114). As another process, when there is no change in the job setting information, the controller 100 acquires image data without storing the job setting information again, for example.

Note that, the above-described operation procedure is merely an example, and a partially different process may be performed. In the present embodiment, in the process of S308, it is possible to perform a process of causing the user to select display of the encryption setting screen in order to perform the setting other than the first password (for example, accessibility, a permission change password and the like), for example.

### 3.2.2 Password Input Process

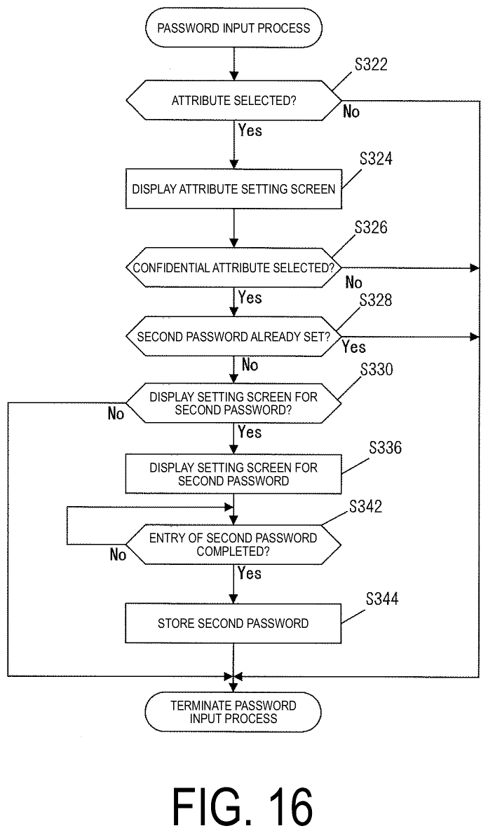

FIG. 16 is a diagram illustrating a procedure of a password input process in the present embodiment.

The controller 100 determines whether the attribute has been selected (S322). The controller 100 may determine that attribute has been selected when a setting item related to attribute or an icon related to attribute setting is selected by the user from among the setting items displayed on the job setting screen, for example.

Note that, the term “attribute” refers to, for example, additional information that can be attached to a file. The controller 100 can read the attribute information attached to a file to determine the file and execute a predetermined process on the file, for example. An example of attribute information includes confidential attribute information that allows the file to be used by a specific recipient by specifying the recipient or protecting the file with a password in a scan job, for example.

Here, as confidential attribute information, for example, confidential attribute information that identifies the execution of processing on the file, and a confidential password (second password) are stored in the file. In a scan job, such as a scan-to-save job, the controller 100 can permit use of the file saved in the folder when a specific user, who is the recipient of the file, enters the second password.

When the controller 100 determines that attribute has been selected, the controller 100 displays an attribute setting screen (S322; Yes→S324). As the attribute setting screen, the controller 100 may display, on the display 140, a display screen that includes setting items and setting values related to attributes in a given form such as a dialog and a pull-down menu in the job setting screen and that allows a change in setting value.

Subsequently, the controller 100 determines whether a confidential attribute has been selected (S326). The controller 100 may determine that a confidential attribute has been selected when the job setting information storage area 1110 stores a confidential attribute as attribute information, and may also determine that a confidential attribute has been selected when the job type is scan-to-save.

When determining that a confidential attribute has been selected, the controller 100 determines whether the second password is stored (already set) in the job setting information (S326; Yes→S328). When determining that the second password has not been set, the controller 100 may determine whether the setting screen for the second password is to be displayed, for example, whether instruction for displaying the setting screen for the second password has been received from the user (S328; No→S330).

When the controller 100 determines that the setting screen for the second password is to be displayed, the controller 100 displays the setting screen for the second password (S330; Yes→S336).

Here, as the setting screen for the second password, the controller 100 may display, on the display 140, a display screen for the user to enter the confidential password (second password) in a given form such as a dialog and a pull-down menu, for example.

Subsequently, the controller 100 determines whether entry of the second password has been completed (S342).

Here, as the method of determining whether entry of the second password has been completed, the controller 100 may determine that entry of the second password has been completed when the user selects a determination key or the execution key on the setting screen for the second password, for example. When the controller 100 determines that entry of the second password has not been completed, the process is repeated until it determines that entry of the second password has been completed (S342; No→S342).

On the other hand, when the controller 100 determines that entry of the second password has been completed, the controller 100 stores the second password in the job setting information (S342; Yes→S344). On the other hand, when the attribute has not been selected (S322; No), when the confidential attribute has not been selected (S326; No), when it is determined that the second password has been set (S328; Yes), and when the setting screen for the second password is not to be displayed (S330; No), the controller 100 terminates the password input process.

### 3.2.3 Password Determination Process

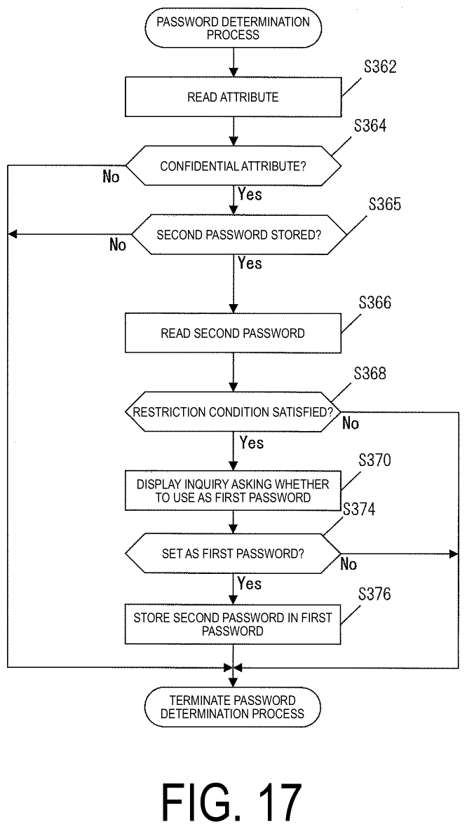

FIG. 17 is a diagram illustrating a procedure of a password determination process in the present embodiment.

The controller 100 reads the attribute (S362). The controller 100 reads information related to the attribute from the job setting information stored in the job setting information storage area 1110, for example.

Subsequently, the controller 100 determines whether the job attribute is confidential on the basis of the job setting information (S364). When the job attribute is confidential, the controller 100 determines whether the second password is stored in the job setting information (S364; Yes→S365), for example. When the controller 100 determines that the second password is stored, the controller 100 reads the second password from the job setting information stored in the job setting information storage area 1110 (S365; Yes→S366).

Next, the controller 100 determines whether the second password satisfies the restriction conditions for use as the first password (S368). Here, the controller 100 determines whether the setting value of the second password satisfies the restriction conditions by means of the password determiner 1020.

When the controller 100 determines that the setting value of the second password satisfies the restriction conditions, the controller 100 displays a screen including a message that inquires of the user whether to use the second password as the first password (S368; Yes→S370). Here, the controller 100 may display, on the display 140, a notification indicating that the setting value of the second password satisfies the restriction conditions together with the display screen including the message that inquires of the user whether to use the second password as the first password, for example.

Subsequently, the controller 100 determines whether to set the second password as the first password (S374). The controller 100 may determine that it is to be set as the first password when the user selects the use of the second password as the first password on the display screen, for example.

When the controller 100 determines that the second password is to be set as the first password, the controller 100 stores the second password as the first password (S374; Yes→S376). The controller 100 may change the setting value of the second password included in the job setting information to the setting value of the first password. On the other hand, when the controller 100 determines that the second password is not to be set as the first password, the controller 100 terminates the password determination process (S374; No→end of password determination process).

In addition, when attribute is not confidential (S364; No), when the second password is not stored (S365; No), and when the restriction conditions are not satisfied (S368; No), the controller 100 terminates the password determination process.

Note that, the above-described operation procedure is merely an example, and a partially different process may be performed. In the present embodiment, for example, the processes of S368 and S370 may be omitted and the process of S374 may be changed such that when the second password is stored as the first password, a notification that the second password is set as the first password is provided to the user and then the second password is stored in the job setting information. Further, the processes of S368, S370 and S374 may be omitted, such that when the second password is set, the second password is stored as the first password.

### 3.3 Exemplary Operation

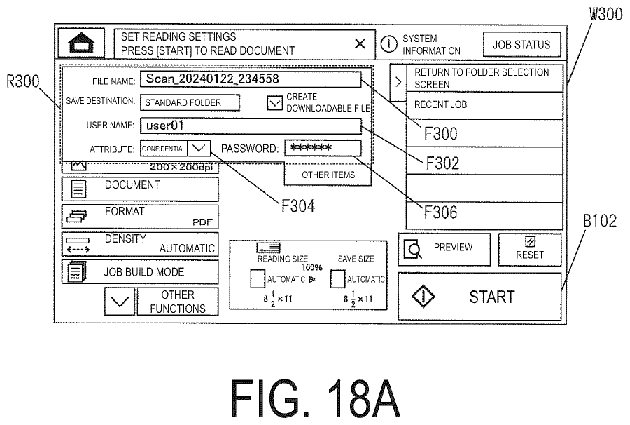

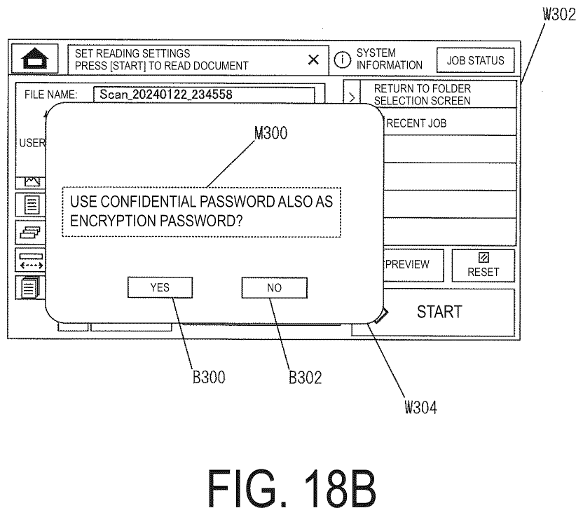

FIGS. 18A and 18B are diagrams illustrating examples of a display screen including a message that is displayed to the user as an operation result of the image forming apparatus 10 in the present embodiment.

FIG. 18A is a diagram illustrating an example of a display screen W300 displayed on the display 140 of the image forming apparatus 10. It is a diagram illustrating an example of an attribute setting screen and a job setting screen including a message that is displayed to the user on the display screen W300 when the user selects the other items button B103 in FIG. 7A. In an area R300 of the display screen W300, a file name input form F300, a user-name input form F302, an attribute input form F304, a confidential password input form F306, a file save destination, and a check box for creating a downloadable file are displayed. Further, the display screen W300 displays the start button B102 serving as an execution key.

Here, the user selects the file name input form F300, and enters a file name “Scan_20240122_234558”. Next, the user selects the user-name input form F302, and enters “User01” as a recipient. Note that, the entry of the file name and the user name is not mandatory, and the controller 100 may display an automatically generated file name as an initial value, and “user name unknown” may be indicated for the user name as an initial value when the authentication is OFF, for example. Then, the user selects the attribute input form F304, and selects a confidential attribute from options (shared, protected, and confidential) displayed in the form of a pull-down menu. Finally, the user selects the confidential password input form F306, and enters the confidential password. Here, the controller 100 may apply the number of characters (input conditions) that can be entered into the confidential password input form F306 in accordance with the encryption level, or may apply any number of characters on the basis of administrator settings regardless of the encryption level. Then, when the user selects the start button B102, the controller 100 displays a display screen W302 of FIG. 18B. Note that, as an example, the controller 100 may be able to use the confidential password as the encryption password only when “CREATE DOWNLOADABLE FILE” is effective. In this manner, in the case of confidential, the user can create a downloadable file as an encrypted PDF.

FIG. 18B is a diagram illustrating an example of the display screen W302 displayed on the display 140 of the image forming apparatus 10 and a window display W304 superimposed on the display screen W302. The display screen W302 is a diagram illustrating an example of a display screen including a message that is displayed to the user in the case where the user selects the start button B102 on the display screen W300 of FIG. 18A, and the confidential password satisfies the password policy, for example.

The display screen W302 displays the window display W304 as a dialog, for example. The window display W304 displays a message M300 stating “USE CONFIDENTIAL PASSWORD ALSO AS ENCRYPTION PASSWORD?”, a yes button B300, and a no button B302. When the yes button B300 is selected, the controller 100 may store the second password as the first password, execute scanning on the basis of the job setting information stored in the job setting information storage area 1110, and save the encrypted file in the designated folder, for example.

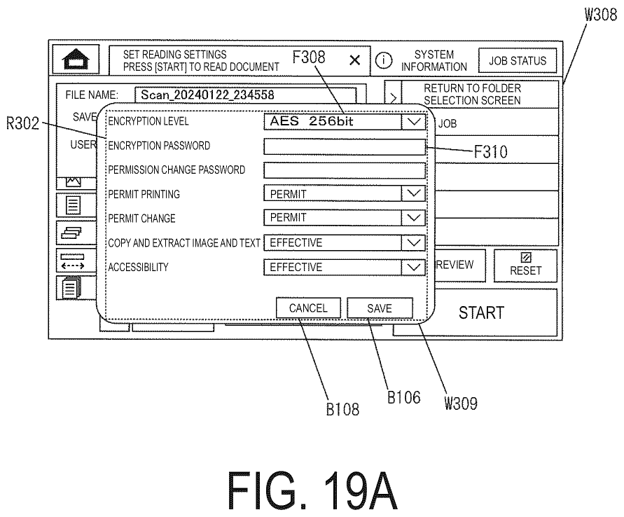

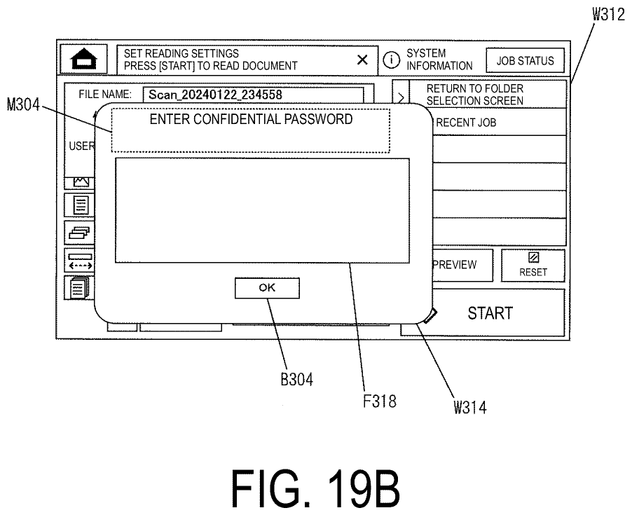

Note that, when the user selects the yes button B300 in the case where the other encryption setting items (for example, a permission change password, accessibility and the like) can be set, the controller 100 may store the second password as the first password, and display a display screen W308 and a window display W309 of FIG. 19A, for example. On the other hand, when the user selects the no button B302, the controller 100 displays the display screen W308 and the window display W309 of FIG. 19A without storing the first password, for example.

Note that, when the confidential password does not satisfy the encryption password requirement (password policy), the controller 100 may display the display screen W308 and the window display W309 of FIG. 19A as it is without storing the second password as the first password, for example. In addition, the controller 100 may notify the user of the fact that the encryption password requirement (password policy) is not satisfied, or display a display screen for inputting only the encryption password (the encryption setting screen), for example.

FIG. 19A is a diagram illustrating an example of the display screen W308 displayed on the display 140 of the image forming apparatus 10 and the window display W309 superimposed on the display screen W308. The display screen W308 is a diagram illustrating an example of the encryption setting screen (display screen) including a message that is displayed to the user in the case where the user selects the no button B302 in the window display W304 superimposed on the display screen W302 of FIG. 18B, and in the case where the confidential password (second password) entered by the user in the confidential password input form F306 of the display screen W300 does not satisfy the password policy, for example.

The display screen W308 displays the window display W309 as a dialog. In an area R302 of the window display W309, an encryption level input form F308, an encryption password input form F310, the save button B106, the cancel button B108, and input forms for other encryption settings (a permission change password, permit printing, permit change, copy and extract image and text, and accessibility) are displayed. Note that, the display screen W308 may or may not optionally display one or more items in the input forms for other encryption settings. Note that, the window display W309 of FIG. 19A may be displayed as with the window display W112 of FIG. 9A, for example.

Here, when the user selects the encryption level input form F308, the controller 100 displays a pull-down menu for the encryption level input form F308, and displays encryption algorithms such as AES 128-bit and RC4 128-bit in addition to AES 256-bit, for example.

Next, the user selects the encryption password input form F310. When the user selects the no button B302 on the display screen W302 of FIG. 18B, and does not use the confidential password as the encryption password, the controller 100 displays the screen with no input for the encryption password. In addition, also when the confidential password does not satisfy the password policy, the controller 100 displays the screen with no input for the encryption password. On the other hand, when the yes button B300 is selected on the display screen W302 of FIG. 18B, and the controller 100 displays the display screen W308, the controller 100 may display the screen with the encryption password already entered, for example.

When the user selects the save button B106, the controller 100 executes scanning on the basis of the job setting information stored in the job setting information storage area 1110, and saves the encrypted file in the designated folder. Note that, when the user selects the cancel button B108, the controller 100 displays the display screen W300 of FIG. 18A.

FIG. 19B is a diagram illustrating an example of a display screen W312 displayed on the display 140 of the image forming apparatus 10 and a window display W314 superimposed on the display screen W312. The display screen W312 is a diagram illustrating an example of the setting screen for the second password (display screen) including a message that is displayed to the user instead of directly entering the confidential password input form F306 in the case where the user selects the confidential password input form F306 on the display screen W300 of FIG. 18A, for example. On the display screen W312, the window display W314 is displayed as a dialog, for example. In the window display W314, a message M304 stating “ENTER CONFIDENTIAL PASSWORD”, a confidential password input form F318, and an OK button B304 are displayed.

Here, the user selects the confidential password input form F318 and inputs the confidential password. Next, when the user selects the OK button B304, the controller 100 stores the password entered into the confidential password input form F318 as the second password in the job setting information storage area 1110. Next, the controller 100 displays the confidential password input form F306 of the display screen W300 of FIG. 18A with the confidential password (second password) entered therein. Here, the controller 100 needs only to indicate that a confidential password has been entered, and therefore may indicate the password by replacing it with a predetermined symbol or character string, such as “*”.

In the present embodiment, the passwords entered in each input form are hidden on the display screen so that the entered passwords cannot be identified from the screen (for example, by being replaced with “*”). However, the passwords may also be displayed such that the entered characters are visible on the display screen. In addition, the screen may display a toggle button that enables the user to switch between showing and hiding the password.

In this manner, in the present embodiment, when the confidential attribute is selected, the confidential password (second password) has already been set and the confidential password (second password) is stored as the encryption password (first password), a process of setting the confidential password (second password) as the encryption password (first password) is executed without displaying the encryption setting screen. When the confidential password (second password) is not stored as the encryption password (first password), the entry of the encryption password (first password) may be received on the encryption setting screen displayed by the controller 100.

In addition, for example, in the case where the confidential attribute is not selected as in the scan-to-send job, the entry of the encryption strength (encryption level) and the corresponding encryption password are received on the encryption setting screen displayed by the controller 100. The user can set a desired, more secure password as the confidential password, and also use it as the encryption password.

Further, in the present embodiment, when a confidential password (second password) is set, the controller 100 may change the encryption strength to a specific encryption strength. For example, the encryption strength may be changed to a first encryption strength as the specific encryption strength, thereby setting a higher-strength algorithm in the case of scan-to-save.

Note that, in the present embodiment, the password determiner 1020 determines whether the input confidential password satisfies the password policy (restriction conditions) serving as the encryption password. Here, for example, when the entered confidential password is designed to satisfy the password policy as an encryption password, the password determiner 1020 may be omitted. The controller 100 may determine whether the confidential password (second password) has already been entered, and when it has already been entered, the controller 100 may display the display screen W302 illustrated in FIG. 18B by regarding it as usable as the encryption password (first password).

### 3.4 Effects, etc.

As described above, in the case where the controller 100 uses the confidential password as the encryption password, the controller 100 can execute the process by setting the confidential password as the encryption password when the confidential password has already been set. Further, in the case where the confidential password has not already been set, the controller 100 can set the encryption password by displaying the encryption setting screen. In this manner, the encryption password required for saving/sending the encrypted file can be appropriately set while reducing the input effort required for the user.

In addition, when the confidential attribute has been selected, encryption can be executed by setting the encryption password within a key length range (for example, 33 digits or more) that is usable with a high-security encryption algorithm (for example, AES 256-bit). Further, in the case of scan-to-send, an encryption setting screen for setting the encryption password, encryption level, and the like can be displayed, whereas in the case of scan-to-save, if a confidential password has already been entered in advance, the display of the encryption setting screen can be omitted. In this manner, the display of the encryption setting screen can be controlled in accordance with the job type.

### 4. Variations

The present disclosure is not limited to the above-described embodiments, and various modifications may be made.

That is, embodiments obtained by appropriately combining technical means modified within the scope not departing from the gist of the present disclosure are also included within the technical scope of the present disclosure.

The above-described embodiments have explained an image forming apparatus as an example of the image processing apparatus. However, the image processing apparatus is also applicable to other apparatuses. For example, the image processing apparatus may be an information processing apparatus such as a smartphone or tablet.

Moreover, in the above-described embodiments, each embodiment has been described separately for the sake of explanation; however, they may be implemented in combination to the extent possible. In addition, any of the technologies described in the specification are intended to be subject to rights acquisition through amendment, divisional application, or the like.

In addition, in each of the embodiments, the program that operates on each apparatus is a program (a program that enables the computer to function) that controls a CPU or the like so as to implement the functions of the above-described embodiments. Information handled by these apparatuses is temporarily stored in a volatile memory (e.g., RAM) during processing, and is subsequently stored in storage apparatuses such as various ROMs or HDDs, from which it is read, modified, and written by the CPU as necessary.

Here, the recording medium for storing the program may be any of the following: a semiconductor medium (e.g., ROM or a non-volatile memory card), an optical recording medium or magneto-optical recording medium (e.g., digital versatile disc (DVD), compact disc (CD), Blu-ray (trade name) disc (BD)), or a magnetic recording medium (e.g., magnetic tape, flexible disk), among others.

In addition, when distributing to the market, the program may be stored on a portable recording medium for distribution, or may be transferred to a server computer connected via a network such as the Internet. In this case, the storage apparatus of the server apparatus is, of course, also included within the scope of the present disclosure.

Moreover, the above-described data may not necessarily be stored within the apparatus, but may instead be stored in an external apparatus and retrieved as needed. For example, the data may be stored in a network attached storage (NAS) or in the cloud.

The scope of the present disclosure is not limited to the configurations explicitly described in the specification, and combinations of the technologies disclosed herein are also included within the scope of the present disclosure. While the configurations for which patent protection is sought are described in the appended claims, it is not the intention to exclude from the technical scope those features not explicitly stated in the claims.

In addition, descriptions such as “in the case of . . . ” or “when . . . ” in the above specification are provided merely as examples, and are not intended to limit the configuration to the described content. Configurations other than those described in such cases are also disclosed to the extent obvious to those skilled in the art, and rights are intended to be secured for such configurations.

Further, the description of processes or data flows with an indicated order in the specification is not limited to the described order. For example, configurations in which certain steps are omitted or the order of steps is rearranged are also disclosed, and rights are intended to be secured for such configurations.

Moreover, while the functions described in the embodiments are explained as being executed by respective apparatuses, they may also be implemented by a single apparatus or, further, by utilizing an external server.

Moreover, the functional blocks or various features of the apparatuses used in the above-described embodiments may be implemented or executed by electric circuits, such as an integrated circuit or a plurality of integrated circuits. An electric circuit designed to perform the functions described in this specification may include a general-purpose processor, a digital signal processor (DSP), an application-specific integrated circuit (ASIC), a field-programmable gate array (FPGA), or other programmable logic devices, discrete gate or transistor logic, discrete hardware components, or combinations thereof.

The general-purpose processor may be a microprocessor, or it may be a known processor, controller, microcontroller, or state machine. The above-mentioned electric circuit may be configured as a digital circuit or an analog circuit. Further, if new integrated circuit technologies that replace current integrated circuits emerge due to advancements in semiconductor technology, one or more aspects of the present disclosure may also be implemented using such new integrated circuit technologies.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. An image processing apparatus comprising:
an acquirer that acquires image data from an image; and
one or more controllers that encrypt the image data based on a key, and outputs, as a file, the image data encrypted, wherein
the one or more controllers change an input condition for input of the key based on an encryption strength for encryption of the image data.

2. The image processing apparatus according to claim 1, wherein the encryption strength is classified by an enterable key length of the key corresponding to an encryption algorithm for execution of the encryption.

3. The image processing apparatus according to claim 2, further comprising a display, wherein
the one or more controllers display, on the display, a setting screen where the key is enterable within a range of the key length based on the input condition.

4. The image processing apparatus according to claim 3, wherein when the encryption algorithm is fixed as a predefined value, the one or more controllers prohibit a change of the encryption algorithm on the setting screen.

5. The image processing apparatus according to claim 1, wherein
the file includes the key as a first password,
a second password for a specific user to use the file is further settable as the first password, and
the one or more controllers set the second password as the first password.

6. The image processing apparatus according to claim 5, wherein when the second password is stored as the first password, the one or more controllers set the second password as the first password.

7. The image processing apparatus according to claim 5, further comprising a display, wherein
when the second password is not stored as the first password, the one or more controllers display, on the display, a setting screen where the first password is settable.

8. A setting method comprising:
acquiring image data from an image; and
encrypting the image data based on a key, and outputting, as a file, the image data encrypted, wherein
in the encrypting, an input condition for input of the key is changed based on an encryption strength for encryption of the image data.
